(19) United States
(12) Patent Application Publication
(10) Pub. No.: US 2003/0236797 A1
(43) Pub. Date: Dec. 25, 2003

(54) File processing program storage medium, file processing apparatus, and file processing method

(75) Inventor: Mio Nita, Inagi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/329,443

(22) Filed: Dec. 27, 2002

(30) Foreign Application Priority Data
Jun. 24, 2002 (JP) 2002-182406

(51) Int. Cl. G06F 17/30

(52) U.S. Cl. 707/200

(57) ABSTRACT

A file processing apparatus performs alteration of file names, and deletion, shift or copy of files. The file processing apparatus performs processing for alteration of file names, and deletion, shift or copy of files, without adding a new file for management when the related files exist, upon providing matching on the related files. For example, in the event that a file name is altered, a file name of one's own file (a processing object file) is altered, while a file name of the processing object file is altered.

### BACKGROUND OF THE INVENTION

1. Field of the Invention

The present invention relates to a file processing method and apparatus for performing alteration of file names, and deletion, shift or copy of files, and a file processing program storage medium storing a file processing program which causes an information processing apparatus such as a computer to be operated as the file processing apparatus, when the file processing program is executed in the information processing apparatus.

2. Description of the Related Art

A user of a personal computer (hereinafter, it may happen that the personal computer is denoted as PC) performs processing for alteration of file names, shift, copy, and deletion for files, on various files in the PC.

Recently, digital still cameras (hereinafter, it may happen that the digital still camera is denoted as DSC) have come into wide use rapidly, and it is spread that a still picture file, which is obtained through photography by the DSC, is taken into PC, and naming the still picture file, shift, copy, deletion for files and other processing are performed. It may happen that the still picture file obtained by the DSC is related with a sound file in which the state of affairs involved in the photography for obtaining the still picture file is recorded with sound. As a file suitable to the DSC, which relates the still picture file with the sound file, there is generally used an Exif type of file.

Here, there will be explained Exif.

Exif is an abbreviation of exchangeable image file format, and is an image format standardized in JEIDA (Japan Electronic Industry Development Association). This Exif is based on the existing all-purpose image format TIFF and JPEG, in which inherent information in the digital camera and working regulations are added. In a revision to Version 2.1, regulations related to the sound file are added.

The Exif type of image file comprises an image data section as to real data and a header information section capable of describing various types of information as to the image data. A field for describing information in the header information section is referred to as a tag. In the Exif type of image file, there exists a tag for describing a file name of the related sound file. In the Exif type of sound file, there exists a tag for describing a file name of the related image file in the same file structure as that of the image data section as to real data and the header information section as mentioned above.

Incidentally, in http://it.jeita.or.jp/jhistory/ document/standard/exif_jap/jeida49jap.htm, standard documents are published.

Conventionally, in PC, processing for alteration of file names, shift, copy, and deletion for files, is generally widely performed. However, according to such processing, in the event that the related files as in the above-mentioned Exif type of file are linked, matched processing on the related files also is not performed. As to whether the related file exists, the user oneself grasps it, and the processing for files oneself is performed in accordance with the user's operation on each file.

However, in the event that there is a need to perform processing only independent of for each file even where there is a possibility that the related files as in the above-mentioned Exif type of file exist, only a user, who knows that the related files have to be simultaneously processed, can performs a proper file processing. Or alternatively, even if the user, who is skilled in the are, is concerned, carelessly forgetting the processing for the related files may bring about mismatching between the related files. Thus, there is a possibility that such mismatching interferes with saving and processing.

With respect to alteration of the names of files, according to FrontPage (trademark) of Microsoft Co., which is the creation software of HTML file, upon receipt of alteration of file names of an HTML file described in the HTML file as a link destination, and a still picture file, the alteration is performed, while the description of the link within the HTML file works together too.

However, this technology is concerned with a one-way scheme in which when a file name of a still picture file and the like is altered, the alteration is performed while a description the link within the HTML file works together. Thus, this technology cannot be applied to a case where even in the event that a file name of any one of a plurality of files related with one another, for example, Exif type of still picture file and a sound file, is altered, there is a need to reflect the alteration of the file name on the related remaining files.

Japanese Patent Publication TokuKai. 1997-288606 discloses such a technique that when shift of a file, alteration of a file name, deletion and the like occurred, for the purpose of maintaining a link relation between the file of interest and a file linked to the file of interest, there is provided a tracking file for tracking a state of link of both files other than their files to perform a management, and information in the tracking file is rewritten when alteration of the file name, shift of the file and the like occur.

However, according to the technique disclosed in the above-referenced Japanese Patent Publication TokuKai. 1997-288606, there is needed the new file addressed as the tracking file and thus there is needed a wide storage area. Further, this involves a complicated file structure and thus involves a lowering of a processing speed when the related plurality of files performs any combination processing.

### SUMMARY OF THE INVENTION

In view of the foregoing, it is an object of the present invention to provide a file processing apparatus and method for performing processing for alteration of file names, and deletion, shift or copy of files, without adding a new file for management when the related files exist, upon providing matching on the related files, and a file processing program storage medium storing a file processing program which causes an information processing apparatus to be operated as the file processing apparatus, when the file processing program is executed in the information processing apparatus.

To achieve the above-mentioned object, the present invention provides a first file processing program storage medium storing a file processing program to be executed by an information processing apparatus, said file processing program causing said information processing apparatus to operate as a file processing apparatus for performing a file name alteration processing of a file having a specific file structure in which a tag recording a file name of related file stored in a folder defined as a storage area of a file is included, said file processing apparatus comprising:

a file name alteration instruction section for instructing alteration of a file name of a desired processing object file; and

a file name rewriting processing section receiving a file name alteration instruction for a processing object file by said file name alteration instruction section to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

According to the first file processing program storage medium of the present invention, in the event that a file name is altered, a file name of one's own file (a processing object file) is altered, while a file name of the processing object file is altered. Thus, the alteration of the file name is reflected on the related file with matching so that the association between the files is maintained.

In the first file processing program storage medium according to the present invention as mentioned above, it is acceptable that said a file name rewriting processing section specifies related file in accordance with the file recorded on the tag of the processing object file, and rewrites the file name recorded on the tag of the related file, of the files stored in same folder as the folder storing the processing object file. In the first file processing program storage medium according to the present invention as mentioned above, it is preferable that said file name rewriting processing section retrieves tags of a file stored in same folder as the folder storing the processing object file to detect related file including a tag recording the file name of the processing object file, and rewrites the file name recorded on the tag of the detected related file.

In the first file processing program storage medium according to the present invention as mentioned above, it is acceptable that the file having the specific file structure is a still picture file and a sound file, and the still picture file includes a tag recording a file name of the sound file and the sound file includes a tag recording a file name of the still picture file. Or alternatively, it is acceptable that the file having the specific file structure includes a tag recording a file name of only one related file.

By way of example, in case of an Exif type of file, it is permitted that only one file name of the related file is recorded on a tag. Accordingly, in case of an Exif type of file, when the file name of the related file is recorded on a tag, there is a possibility that two related files exist.

Usually, there exists only one sound file related with a still picture file. In a case where such a restriction is added or in a case where there is provided a standard in which file names of a plurality of related files can be freely recorded in a tag, it is acceptable that the related file is specified from the file names recorded on the tag, so that an alteration of the file name is reflected on the specified related file. In the event that it is permitted that only one file name of the related file is recorded on a tag, and there is a possibility that a plurality of related files exists, it is preferable that in view of the fact that the tag records the file name of the related file, it is known only that the related file exists, and with respect to what file is the related file, tags of files of the same folder as the folder storing the file to be altered in the file name are retrieved, the file recording the file name before alteration of the file which is intended to be altered in the tag with the file name is detected, and the alteration of the file name is reflected on the related file where the thus detected file is established as the related file.

Incidentally, in case of the Exif type, regarding a file (a processing object file) in which a tag records the file name of the related file, even if the related file is deleted, the file name of the related file is left on the tag of the processing object file. That is, the fact that the tag records the file name of the related file fails to guarantee that the related file always exists. And it simply provides a presumption of existence of the related file.

In the first file processing program storage medium according to the present invention as mentioned above, it is acceptable that the file having the specific file structure is one in which a recording format of the file name of related file recorded on a tag is determined, and said file name alteration instruction section receives only input operation conformed to the recording format for a file name of the processing object file.

In case of the Exif type of file, a file name of the related file recorded on the tag is determined in sort of characters and recording format of the number of characters and the like (for example, the number of English letters and the number of figures, and the total number of letters and figures). Thus, for example, in the event that the recording format of the file name of the related file recorded on the tag is determined, the alteration of the file name receiving only the input operation conforming to the recording format makes it possible to enter a proper file name conforming to the recording format, even if a user's knowledge level does not reach a proper understanding.

To achieve the above-mentioned object, the present invention provides a second file processing program storage medium storing a file processing program to be executed by an information processing apparatus, said file processing program causing said information processing apparatus to operate as a file processing apparatus, said file processing apparatus comprising:

a file processing instruction section for instructing processing for a desired processing object file in accordance with an operation; and

a file processing section receiving a processing instruction for a processing object file by said file processing instruction section to execute processing for the processing object file, and also to execute processing of same contents as said processing for related file linked to the processing object file.

The second file processing program storage medium of the present invention operates together with the processing for the processing object file to execute processing of the same object as said processing for the related file. This feature makes it possible to maintain the association of those files.

In the second file processing program storage medium according the present invention as mentioned above, it is acceptable that said processing object file has a specific file structure in which a tag recording a file name of related file stored in a folder defined as a storage area of a file is included, and

said file processing section executes said processing where a file including a tag recording the file name of the processing object file of the files stored in the folder storing the processing object file is established as related file linked to the processing object file.

In the second file processing program storage medium according to the present invention as mentioned above, it is acceptable that said file processing section specifies related file in accordance with the file recorded on the tag of the processing object file, and executes said processing for the related file of the files stored in same folder as the folder storing the processing object file. Or alternatively it is acceptable that said file processing section retrieves tags of a file stored in same folder as the folder storing the processing object file to detect related file including a tag recording the file name of the processing object file, and executes said processing for the detected related file.

In the second file processing program storage medium according to the present invention as mentioned above, it is acceptable that the file having the specific file structure is a still picture file and a sound file, and the still picture file includes a tag recording a file name of the sound file and the sound file includes a tag recording a file name of the still picture file. Or alternatively, it is acceptable that the file having the specific file structure includes a tag recording a file name of only one related file.

In the second file processing program storage medium according to the present invention as mentioned above, it is preferable that said file processing apparatus further comprises:

a processing question section receiving an instruction of processing for the processing object file by said file processing instruction section to inquire of an operator whether processing of same content as said processing is executed for the related file linked to the processing object file; and

a propriety instruction section for instructing propriety of execution of said processing for the related file in accordance with an operation of the operator who receives the question by said processing question section, and

said file processing section receives an admission by said propriety instruction section and executes said processing for the related file.

When processing for a file (a processing object file) is instructed, function of causing a user to select between the execution of processing for the related file too and leaving the related file without executing the processing for the related file makes it possible to increase a degree of freedom of the file processing for the user.

In the second file processing program storage medium according to the present invention as mentioned above, it is acceptable that the processing for the processing object file is a deletion of the processing object file, and said file processing section deletes the related file together with the processing object file. Or it is acceptable that the processing for the processing object file is a shift of the processing object file, and said file processing section shifts the processing object file to the folder designated by said operation and shifts the related file to the same folder.

Or alternatively, it is acceptable that the processing for the processing object file is a copy of the processing object file, and said file processing section copies the processing object file onto the folder designated by said operation and copies the related file to the same folder.

To achieve the above-mentioned object, the present invention provides a third file processing program storage medium storing a file processing program to be executed by an information processing apparatus, said file processing program causing said information processing apparatus to operate as a file processing apparatus, said file processing apparatus comprising:

a file processing instruction section for instructing processing for a desired processing object file in accordance with an operation; and

a file processing section receiving a processing instruction for a processing object file by said file processing instruction section to execute processing for the processing object file, and also to execute processing of a predetermined content different from said processing for related file linked to the processing object file.

The third file processing program storage medium operates together with processing for the processing object file and executes processing of contents different from said processing for the related file. For example, when the processing object file is shifted from the former folder to another folder, deletion of the related file existing on the former folder makes it possible to maintain the association of the remaining files in the former folder. For example, when the processing object file is shifted from the former folder to another folder, copy of the related file existing on the former folder onto a file of a shift destination of the processing object file makes it possible to maintain the association between the files of the folder of the shift destination.

In the third file processing program storage medium according to the present invention as mentioned above, it is acceptable that said processing object file has a specific file structure in which a tag recording a file name of related file stored in a folder defined as a storage area of a file is included, and

said file processing section executes said processing of the predetermined content where a file including a tag recording the file name of the processing object file of the files stored in the folder storing the processing object file is established as related file linked to the processing object file.

In this case, it is acceptable that said a file processing section specifies related file in accordance with the file recorded on the tag of the processing object file, and executes said processing of the predetermined content for the related file of the files stored in same folder as the folder storing the processing object file. Or alternatively, it is acceptable that said file processing section retrieves tags of a file stored in same folder as the folder storing the processing object file to detect related file including a tag recording the file name of the processing object file, and executes said processing of the predetermined content for the detected related file.

In the third file processing program storage medium according to the present invention as mentioned above, similar to the first file processing program storage medium and the second file processing program storage medium, it is acceptable that the file having the specific file structure is a still picture file and a sound file, and the still picture file includes a tag recording a file name of the sound file and the sound file includes a tag recording a file name of the still picture file. Or alternatively it is acceptable that the file having the specific file structure includes a tag recording a file name of only one related file.

In the third file processing program storage medium according to the present invention as mentioned above, it is preferable that said third file processing apparatus further comprises:

a processing question section receiving an instruction of processing for the processing object file by said file processing instruction section to inquire of an operator whether said processing of the predetermined content is executed for the related file linked to the processing object file; and

a propriety instruction section for instructing propriety of execution of said processing of the predetermined content for the related file in accordance with an operation of the operator who receives the question by said processing question section, and

said file processing section receives an admission by said propriety instruction section and executes said processing of the predetermined content for the related file.

When processing for a file (a processing object file) is instructed, function of causing a user to select between the execution of processing for the related file too and leaving the related file without executing the processing for the related file makes it possible to increase a degree of freedom of the file processing for the user.

In the third file processing program storage medium according to the present invention as mentioned above, it is acceptable that the processing for the processing object file is a shift of the processing object file, and said file processing section shifts the processing object file to the folder designated by said operation and deletes the related file as said processing of the predetermined content. Or alternatively, it is acceptable that the processing for the processing object file is a shift of the processing object file, and said file processing section shifts the processing object file to the folder designated by said operation and copies the related file onto the same folder as said processing of the predetermined content.

To achieve the above-mentioned object, the present invention provides a first file processing apparatus for performing a file name alteration processing of a file having a specific file structure in which a tag recording a file name of related file stored in a folder defined as a storage area of a file is included, said file processing apparatus comprising:

a file name alteration instruction section for instructing alteration of a file name of a desired processing object file; and

a file name rewriting processing section receiving a file name alteration instruction for a processing object file by said file name alteration instruction section to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

To achieve the above-mentioned object, the present invention provides a second file processing apparatus comprising:

a file processing instruction section for instructing processing for a desired processing object file in accordance with an operation; and

a file processing section receiving a processing instruction for a processing object file by said file processing instruction section to execute processing for the processing object file, and also to execute processing of same contents as said processing for related file linked to the processing object file.

To achieve the above-mentioned object, the present invention provides a third file processing apparatus comprising:

a file processing instruction section for instructing processing for a desired processing object file in accordance with an operation; and

a file processing section receiving a processing instruction for a processing object file by said file processing instruction section to execute processing for the processing object file, and also to execute processing of a predetermined content different from said processing for related file linked to the processing object file.

The first, second and third file processing apparatuses include various types of file processing apparatuses which are implemented when the file processing programs of the first, second and third file processing program storage mediums are executed in the information processing apparatus, respectively.

In order to achieve the above-described object, the present invention also provides a first method of file processing that performs a file name alteration processing of a file having a specific file structure in which a tag recording a file name of related file stored in a folder defined as a storage area of a file is included, comprising the steps of:

instructing alteration of a file name of a desired processing object file; and

receiving a file name alteration instruction for a processing object file by the step of instructing alteration of a file name of a desired processing object file, to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

Also, the present invention provides a second method of file processing, comprising the steps of:

instructing processing for a desired processing object file in accordance with an operation; and

receiving a processing instruction for a processing object file by the step of instructing processing for a desired processing object file in accordance with an operation, to execute processing for the processing object file, and also to execute processing of same contents as said processing for related file linked to the processing object file.

Moreover, the present invention provides a third method of file processing, comprising the steps of:

instructing processing for a desired processing object file in accordance with an operation; and

receiving a processing instruction for a processing object file by the step of instructing processing for a desired processing object file in accordance with an operation, to execute processing for the processing object file, and also to execute processing of a predetermined content different from said processing for related file linked to the processing object file.

The first, second and third methods of file processing include various types of methods of file processing which are implemented by the first, second and third file processing apparatuses, respectively.

### BRIEF DESCRIPTION OF THE DRAWINGS

FIG. 1 is a view showing a personal computer (PC) in which a file processing apparatus as an embodiment of the present invention is constructed.

FIG. 2 is a hardware construction view of the PC shown in FIG. 1.

FIG. 3 is a view showing an embodiment of a file processing program stored in a file processing program storage medium of the present invention.

FIG. 4 is a functional block diagram of an embodiment of a file processing apparatus of the present invention.

FIG. 5 is a view showing an example of a tag included in Exif type of files.

FIG. 6 is a view showing command rules provided in DCF standards as to Exif type of files.

FIG. 7 is a view showing an example of the association between file names of the related files recorded in tags included in a still picture file and a sound file.

FIG. 8 is a view showing a file processing screen.

FIG. 9 is a view showing a name alteration processing routine.

FIG. 10 is a view showing an example of an alarm dialog.

FIG. 11 is a view showing a file name input dialog.

FIG. 12 is a view showing a file name input dialog.

FIG. 13 is a view showing a file deletion processing routine.

FIG. 14 is a view showing a deletion confirming dialog.

FIG. 15 is a view showing a file shift processing routine.

FIG. 16 is a view showing a shift association confirming dialog.

FIG. 17 is a view showing a file copy processing routine.

FIG. 18 is a view showing a copy confirming dialog.

### DETAILED DESCRIPTION OF PREFERRED EMBODIMENTS

Embodiments of the present invention will be described with reference to the accompanying drawings.

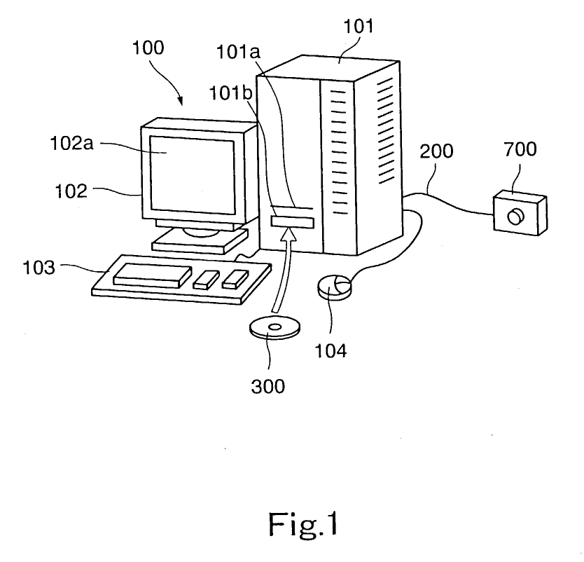

FIG. 1 is a view showing a personal computer (PC) in which a file processing apparatus as an embodiment of the present invention is constructed.

A PC 100 is detachably connected via an USB 200 to a digital still camera (DSC) 700, so that an Exif type of still picture file and a sound file, which are obtained through photography and recording by the DSC 700, are loaded onto the PC 100 so as to be subjected to various types of processing on the PC 100.

The PC 100 comprise: a main frame 101 incorporating therein a CPU (Central Processing Unit), a RAM (Random Access Memory), and a hard disk; a display unit 102 for displaying images and strings of characters on display screen 102a in accordance with instructions from the main frame 101; a keyboard 103 for inputting user's instructions and character information to the PC 100; and a mouse 104 for inputting orders related with icons or the like displayed on positions on the display screen 102a when the positions are designated.

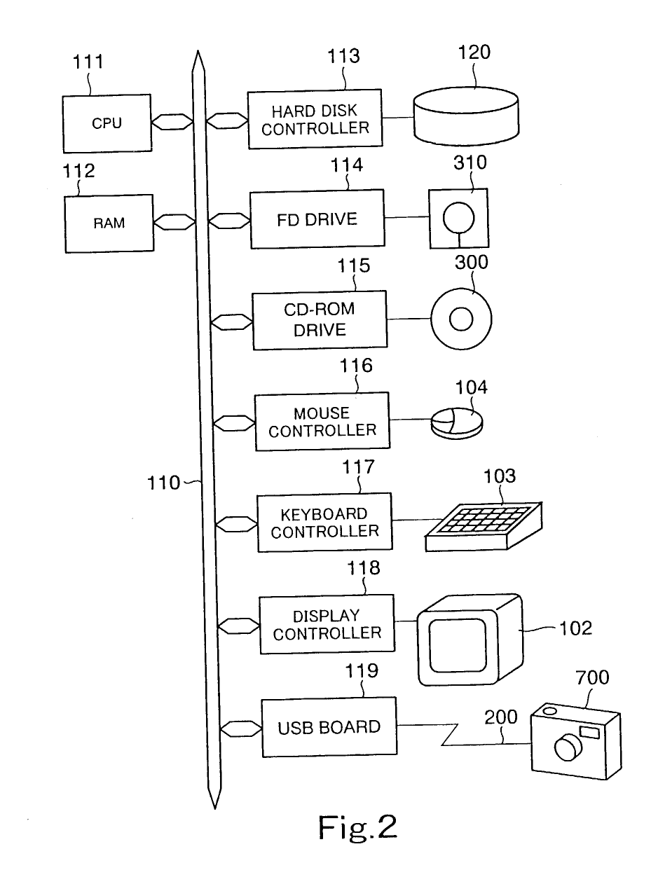

The main frame 101 of the server 100 comprises, on the outside appearance, a flexible disk (not illustrated), a flexible disk mounting slot 101a onto which CD-ROM 300 is loaded, and a CD-ROM mounting slot 101b. Inside the main frame 101, there are incorporated a flexible disk drive 114 (not illustrated in FIG. 1, cf. FIG. 2) for driving the flexible disk loaded through the flexible disk mounting slot 101a, and a CD-ROM drive 115 (not illustrated in FIG. 1, cf. FIG. 2) for driving the CD-ROM 300 loaded through the CD-ROM mounting slot 101b.

FIG. 2 is a hardware construction view of the personal computer shown in FIG. 1.

The hardware construction view of the personal computer shows a central processing unit (CPU) 111, a RAM 112, a hard disk controller 113, a flexible disk drive 114, a CD-ROM drive 115, a mouse controller 116, a keyboard controller 117, a display controller 118, and a USB board 119. Those elements are connected to one another through a bus 110.

The flexible disk drive 114 and the CD-ROM drive 115 access, as described referring to FIG. 1, the flexible disk 310 and the CD-ROM 300, which are loaded through the flexible disk mounting slot 101a and the CD-ROM mounting slot 101b, respectively. The USB board 119 is detachably connected via the USB 200 to the digital still camera (DSC) 700, so that an Exif type of still picture file and a sound file, which are obtained through photography and recording by the DSC 700, are loaded onto the PC 100 so as to be subjected to various types of processing on the PC 100.

FIG. 2 further shows a hard disk 120 to be accessed by the hard disk controller 113, a mouse 104 to be controlled by the mouse controller 116, a keyboard 103 to be controlled by the keyboard controller 117, and a CRT display 102 to be controlled by the display controller 118.

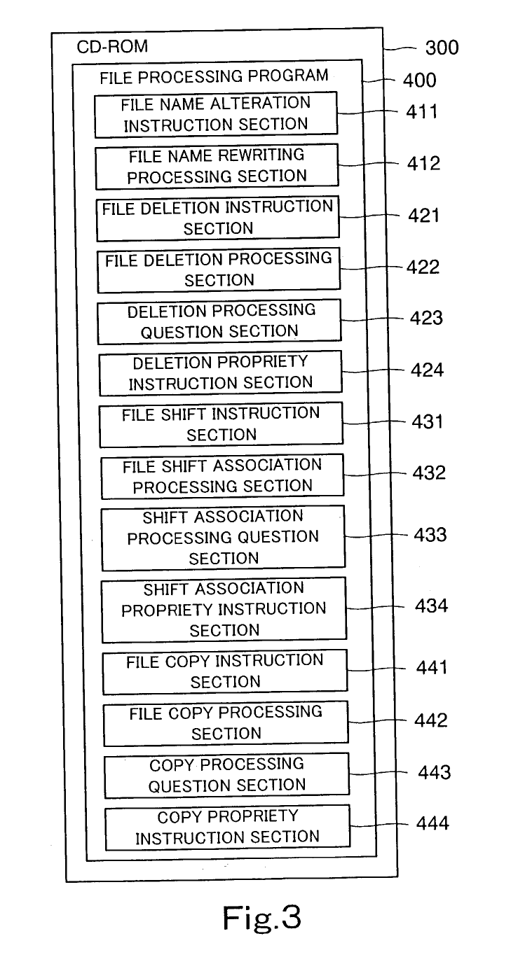

FIG. 3 is a view showing an embodiment of a file processing program stored in a file processing program storage medium of the present invention.

A file processing program 400 shown in FIG. 3 is stored in the CD-ROM 300. The file processing program 400 comprises a file name alteration instruction section 411, a file name rewriting processing section 412, a file deletion instruction section 421, a file deletion processing section 422, a deletion processing question section 423, a deletion propriety instruction section 424, a file shift instruction section 431, a file shift association processing section 432, a shift association processing question section 433, a shift association propriety instruction section 434, a file copy instruction section 441, a file copy processing section 442, a copy processing question section 443, and a copy propriety instruction section 444.

Of the above-mentioned sections 411 to 444 constituting the file processing program 400, the file deletion instruction section 421, the file shift instruction section 431, and the file copy instruction section 441 correspond to examples of the file processing instruction section referred to in the present invention; the file deletion processing section 422, the file shift association processing section 432, and the file copy processing section 442 correspond to examples of the file processing section referred to in the present invention; and the deletion processing question section 423, the shift association processing question section 433, and the copy processing question section 443 correspond to examples of the processing question section referred to in the present invention; and the deletion propriety instruction section 424, the shift association propriety instruction section 434, and the copy propriety instruction section 444 correspond to examples of the propriety instruction section referred to in the present invention.

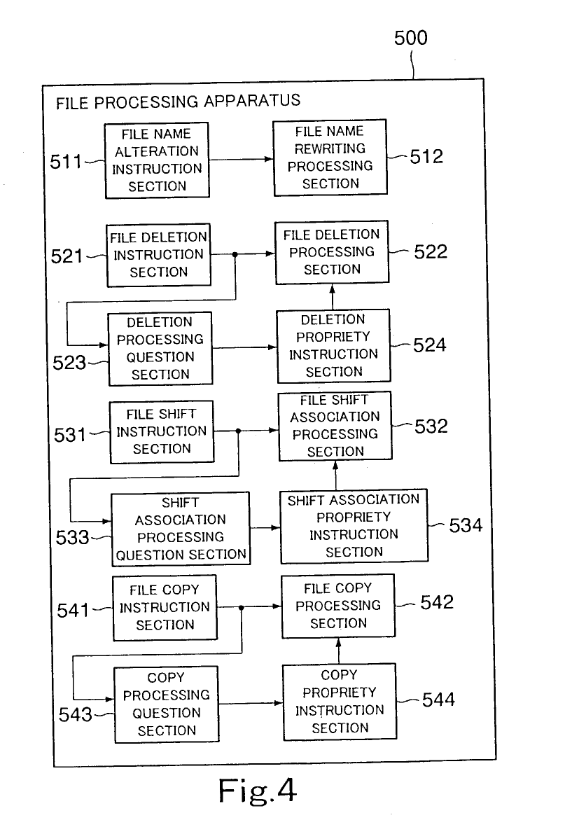

There will be explained functions of the respective elements of the file processing program 400 in conjunction with functions of the respective elements of the file processing apparatus 500 shown in FIG. 4.

The file processing program 400 shown in FIG. 3 is stored in the CD-ROM 300. When the CD-ROM 300 is mounted through the CD-ROM mounting slot 101b of the PC 100 shown in FIG. 1 and is accessed by the CD-ROM drive 115 shown in FIG. 2, the file processing program 400 stored in the CDROM 300 is up loaded onto the PC 100. The file processing program 400 up loaded onto the PC 100 is stored in the hard disk 120 of the PC 100. When the file processing program 400 is executed, the file processing program 400 is read from the hard disk 120, developed in the RAM 112, and then executed by the CPU 111.

While FIG. 3 shows the file processing program 400 stored in the CD-ROM 300, there is no need that the file processing program 400 of the present invention is stored in the CD-ROM. And it is acceptable that the file processing program 400 is stored in another portable type of storage (for example, FD 310 shown in FIG. 2) and is up loaded onto the PC 100, or alternatively, it is acceptable that the PC 100 shown in FIG. 1 and FIG. 2 is connected to a communication network such as Internet and the like, and the file processing program 400 is loaded via the communication network onto the PC 100, further or alternatively, it is acceptable that the file processing program 400 is stored in the hard disk 120 beforehand. In effect, any one is acceptable, as the file processing program 400, which is executed in the PC 100.

FIG. 4 is a functional block diagram of an embodiment of a file processing apparatus of the present invention. A file processing apparatus 500 shown in FIG. 4 is implemented in the PC 100 when the file processing program 400 shown in FIG. 3 is executed in the PC 100 shown in FIG. 1 and FIG. 2.

The file processing apparatus 500 shown in FIG. 4 comprises a file name alteration instruction section 511, a file name rewriting processing section 512, a file deletion instruction section 521, a file deletion processing section 522, a deletion processing question section 523, a deletion propriety instruction section 524, a file shift instruction section 531, a file shift association processing section 532, a shift association processing question section 533, a shift association propriety instruction section 534, a file copy instruction section 541, a file copy processing section 542, a copy processing question section 543, and a copy propriety instruction section 544. The file name alteration instruction section 511, the file name rewriting processing section 512, the file deletion instruction section 521, the file deletion processing section 522, the deletion processing question section 523, the deletion propriety instruction section 524, the file shift instruction section 531, the file shift association processing section 532, the shift association processing question section 533, the shift association propriety instruction section 534, the file copy instruction section 541, the file copy processing section 542, the copy processing question section 543, and the copy propriety instruction section 544 correspond to the file name alteration instruction section 411, the file name rewriting processing section 412, the file deletion instruction section 421, the file deletion processing section 422, the deletion processing question section 423, the deletion propriety instruction section 424, the file shift instruction section 431, the file shift association processing section 432, the shift association processing question section 433, the shift association propriety instruction section 434, the file copy instruction section 441, the file copy processing section 442, the copy processing question section 443, and the copy propriety instruction section 444, of the file processing program 400 shown in FIG. 3, respectively. All the sections constituting the file processing apparatus 500 shown in FIG. 4 are constructed by a combination of the hard ware of the PC 100 shown in FIG. 1 and FIG. 2, an operating system (OS) operating in the PC 100, and the file processing program 400 shown in FIG. 3 as an application program to be executed on the operating system (OS). To the contrary, all the sections constituting the file processing program 400 shown in FIG. 3 are constructed by only the portion of the application program of the combination or compound. The functions of the respective sections constituting the file processing program 400 shown in FIG. 3, as the file processing program 400 is executed in the PC 100, are the same as those of the respective sections constituting the file processing apparatus 500 shown in FIG. 4. Hereinafter, an explanation of the functions of the respective sections constituting the file processing apparatus 500 shown in FIG. 4 will serve as an explanation of the functions of the respective sections constituting the file processing program 400 shown in FIG. 3.

The file name alteration instruction section 511 and the file name rewriting processing section 512, which constitute the file processing apparatus 500 shown in FIG. 4, each include a tag to record a file name of the related file stored in a folder defined as a storage area of a file. The file name alteration instruction section 511 and the file name rewriting processing section 512 perform a file name alteration processing for a file having a specific file structure (in the present embodiment a file structure conforming to the Exif type) in which recording on the tag a file name of a file other than oneself makes it possible to estimate the existence of the related file having that file name. Of the file name alteration instruction section 511 and the file name rewriting processing section 512, the file name alteration instruction section 511 instructs a file name alteration of a desired file of interest as the processing object in accordance with an operation. Of the file name alteration instruction section 511 and the file name rewriting processing section 512, the file name rewriting processing section 512 receives the file name alteration instruction for the file of interest as the processing object by the file name alteration instruction section 511 and rewrites the file name of the file of interest as the processing object by a new file name. And in the event that the tag of the file of interest as the processing object records the file name of the related file, the file name rewriting processing section 512 rewrites the file name of the file of interest as the processing object recorded on a tag of a file including a tag recording the file name of the file of interest as the processing object of the files stored in the same folder as the folder storing the file of interest as the processing object by a new file name of the file of interest as the processing object.

The file name rewriting processing section 512 is related with two modes of a first mode in which the related file is specified in accordance with the file name recorded on the tag of the file of interest as the processing object, and rewrites the file name recorded on the tag of the related file of the files stored in the same folder as the folder storing the file of interest as the processing object, and a second mode wherein in the event that the tag of the file of interest as the processing object records the file name of the related file, the tag of the file stored in the same folder as the folder storing the file of interest as the processing object is retrieved to detect the related file including the tag recording the file name of the file of interest as the processing object, so that the file name recorded on the tag of the related file thus detected is rewritten.

Incidentally, according to the present embodiment, as mentioned above, the Exif type of file is dealt with as the processing object. Accordingly, in the file dealt with in the present embodiment, there exist the still picture file and the sound file. In case of the still picture file, the tag included in the still picture file records the file name of the sound file. In case of the sound file, the tag included in the sound file records the file name of the still picture file.

The file having the above-mentioned specific file structure records a file name of at most one related file on a tag appended to a file of oneself. That is, the file having the specific file structure records no file name of the related file on the tag, or only one file name even in a case where the file name of the related file is recorded on the tag.

Further, in the Exif type of file dealt with in the present embodiment, there is determined a recording format of a file name of the related file recorded on the tag. The file name alteration instruction section 511 receives an input operation conformed to the recording format of a file name of a file of interest as the processing object.

Embodiments of the file name alteration instruction section 511 and the file name rewriting processing section 512 will be described later, and here there will be described the outline of the respective blocks of the file processing apparatus 500 shown in FIG. 4.

The file deletion instruction section 521, the file deletion processing section 522, the deletion processing question section 523, and the deletion propriety instruction section 524, which constitute the file processing apparatus 500 shown in FIG. 4, perform the deletion processing for files. The file deletion instruction section 521 instructs the deletion of a desired processing object file in accordance with an operation. The file deletion processing section 522 receives an instruction of the deletion of the processing object file by the file deletion instruction section 521, and deletes the processing object file and the related file linked to the processing object file as well. The file processing apparatus 500 shown in FIG. 4 performs, also as to the deletion processing for files, the deletion processing for a file having a specific file structure (according to the present embodiment, Exif type of file structure) in which a tag recording a file name of the related file stored in a folder defined as a storage area of a file is applied and a file name of a file other than oneself is recorded on the tag, so that the existence of the related file having the file name is presumed. The file deletion processing section 522 receives an instruction of the deletion of the processing object file by the file deletion instruction section 521, and deletes the processing object file. And in the event that the tag of the processing object file records the file name of the related file, the file deletion processing section 522 deletes, as the related file linked to the processing object file, a file provided with a tag recording the file name of the processing object file of the files stored in the same folder as the folder storing the processing object file.

The file deletion processing section 522 is, similar to the file name rewriting processing section 512, related with two modes of a first mode in which the related file is specified in accordance with the file name recorded on the tag of the file of interest as the processing object, and deletes the related file of the files stored in the same folder as the folder storing the file of interest as the processing object, and a second mode wherein in the event that the tag of the file of interest as the processing object records the file name of the related file, the tag of the file stored in the same folder as the folder storing the file of interest as the processing object is retrieved to detect the related file including the tag recording the file name of the file of interest as the processing object, so that the related file thus detected is deleted.

Of the structure for carrying out the file deletion processing of the file processing apparatus 500 shown in FIG. 4, the deletion processing question section 523 receives an instruction of deletion of the processing object file by the file deletion instruction section 521 and inquires of the operator whether the related file linked to the processing object file is deleted. The deletion propriety instruction section 524 instructs the propriety of the deletion of the related file in accordance with an operation of the operator who receives the question by the deletion processing question section 523. Accordingly, the file deletion processing section 522 receives an instruction of the deletion of the processing object file by the file deletion instruction section 521, and deletes the processing object file. And the file deletion processing section 522 receives a permission of the deletion of the related file by the deletion propriety instruction section 524, and deletes the related file.

The file shift instruction section 531, the file shift association processing section 532, the shift association processing question section 533, and the shift association propriety instruction section 534, which constitute the file processing apparatus 500 shown in FIG. 4, are structure portions for performing a shift processing for a file stored in a folder defined as a storage area of the file to another folder.

The file shift instruction section 531 of the structure portions for performing the shift processing instructs a shift of a desired processing object file to another folder in accordance with an operation. The file shift association processing section 532 receives an instruction of a shift of the processing object file by the file shift instruction section 531 and shifts the processing object file to a folder of a shift destination. And the file shift association processing section 532 shifts the related file stored in the same folder as the folder storing the processing object file, which is linked to the processing object file, to the same folder as the folder of the shift destination of the processing object file, or deletes the related file, or copies the related file onto the same folder as the folder of the shift destination of the processing object file.

The file processing apparatus 500 shown in FIG. 4 performs, also as to the shift processing for files, the shift processing for a file having an Exif type of file structure in which a tag recording a file name of the related file stored in a folder defined as a storage area of a file is included and a file name of a file other than oneself is recorded on the tag, so that the existence of the related file having the file name is presumed. The file shift association processing section 532 receives an instruction of the shift of the processing object file by the file shift instruction section 531, and shifts the processing object file. And in the event that the tag of the processing object file records the file name of the related file, the file shift association processing section 532 shifts, deletes and copies, as the related file linked to the processing object file, a file including a tag recording the file name of the processing object file of the files stored in the same folder as the folder storing the processing object file.

The file shift association processing section 532 is, similar to the file name rewriting processing section 512, and the file deletion processing section 522, related with two modes of a first mode in which the related file is specified in accordance with the file name recorded on the tag of the file of interest as the processing object, and shifts the related file of the files stored in the same folder as the folder storing the file of interest as the processing object, and a second mode wherein in the event that the tag of the file of interest as the processing object records the file name of the related file, the tag of the file stored in the same folder as the folder storing the file of interest as the processing object is retrieved to detect the related file including the tag recording the file name of the file of interest as the processing object, so that the related file thus detected is shifted.

Of the structure for carrying out the file deletion processing of the file processing apparatus 500 shown in FIG. 4, the shift association processing question section 533 receives an instruction of shift of the processing object file by the file shift instruction section 531 and inquires of the operator whether the related file linked to the processing object file is shifted, deleted and copied. The shift association propriety instruction section 534 instructs the propriety of the shift of the related file in accordance with an operation of the operator who receives the question by the shift association processing question section 533.

Accordingly, the file shift association processing section 532 receives an instruction of the shift of the processing object file by the file shift instruction section 531, and shifts the processing object file. And the file shift association processing section 532 receives a permission of shift/the deletion/copy of the related file by the shift association propriety instruction section 534, and shifts/deletes/copies the related file.

The file copy instruction section 541, the file copy processing section 542, the copy processing question section 543, and the copy propriety instruction section 544, which constitute the file processing apparatus 500 shown in FIG. 4, are structure portions for performing a copy processing for a file stored in a folder defined as a storage area of the file to another folder.

The file copy instruction section 541 of the structure portions for performing the copy processing instructs a copy of a desired processing object file to another folder in accordance with an operation. The file copy processing section 542 receives an instruction of a copy of the processing object file by the file copy instruction section 541 and copies the processing object file onto a folder of a copy destination. And the file copy processing section 542 copies the related file stored in the same folder as the folder storing the processing object file, which is linked to the processing object file, onto the same folder as the folder of the copy destination of the processing object file.

The file processing apparatus 500 shown in FIG. 4 performs, also as to the copy processing for files, the copy processing for a file having an Exif type of file structure in which a tag recording a file name of the related file stored in a folder defined as a storage area of a file is included and a file name of a file other than oneself is recorded on the tag, so that the existence of the related file having the file name is presumed. The file copy processing section 542 receives an instruction of the copy of the processing object file by the file copy instruction section 541, and copies the processing object file. And in the event that the tag of the processing object file records the file name of the related file, the file copy processing section 542 copies, as the related file linked to the processing object file, a file including a tag recording the file name of the processing object file of the files stored in the same folder as the folder storing the processing object file.

The file copy processing section 542 is, similar to the file name rewriting processing section 512, the file deletion processing section 522, and the file shift association processing section 532, related with two modes of a first mode in which the related file is specified in accordance with the file name recorded on the tag of the file of interest as the processing object, and copies the related file of the files stored in the same folder as the folder storing the file of interest as the processing object, and a second mode wherein in the event that the tag of the file of interest as the processing object records the file name of the related file, the tag of the file stored in the same folder as the folder storing the file of interest as the processing object is retrieved to detect the related file including the tag recording the file name of the file of interest as the processing object, so that the related file thus detected is copied.

Of the structure for carrying out the file deletion processing of the file processing apparatus 500 shown in FIG. 4, the copy processing question section 543 receives an instruction of copy of the processing object file by the file copy instruction section 541 and inquires of the operator whether the related file linked to the processing object file is copied. The copy propriety instruction section 544 instructs the propriety of the copy of the related file in accordance with an operation of the operator who receives the question by the copy processing question section 543. Accordingly, the file copy processing section 542 receives an instruction of the copy of the processing object file by the file copy instruction section 541, and copies the processing object file. And the file copy processing section 542 receives a permission of copy of the related file by the copy propriety instruction section 544, and copies the related file.

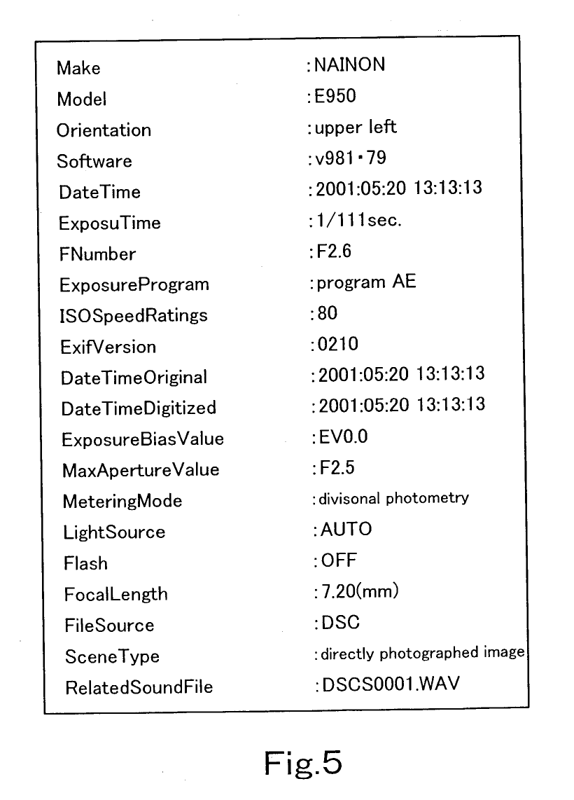

FIG. 5 is a view showing an example of a tag included in Exif type of files. This example is an example of a tag of an Exif type of still picture file.

The still picture file including such a tag is obtained by photograph by the DSC 700 (cf. FIG. 1 and FIG. 2). This tag records thereon the various photographic conditions and the file name “DSCN0001.WAV” of the related sound file at the bottom line. In case of an Exif type of sound file, in this column there is recorded a file name of the related still picture file.

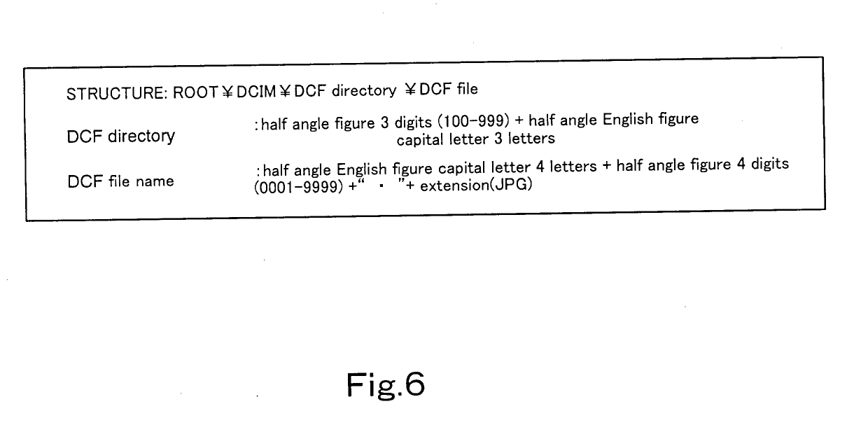

FIG. 6 is a view showing command rules provided in DCF standards as to Exif type of files.

Here, “DCF file” is stored in a folder “¥DCF directory” of a folder “¥DCIM” of a folder “ROOT”. According to DCF (Design rule for Camera File system) standards, it is provided that the “DCF directory” is to be expressed by “half angle figure three digits (100-999)+half angle English figure capital letter three letters”, and it is provided that the file name of the “DCF file” is to be expressed by “half angle English figure capital letter four letters+half angle figure four digits (0001-9999)+“.”+extension (JPG: a case of a still picture file, and WAV: a case of a sound file).

The DCF prescribes specifications as to treatments for recording and reproduction of image files in DSC and the related equipment and files related to images, and is a standard enacted by JEIDA (cf. above-referenced http://it.jeita.or.jp/jhistory/document/standard/exif_jap/j eida49jap.htm).

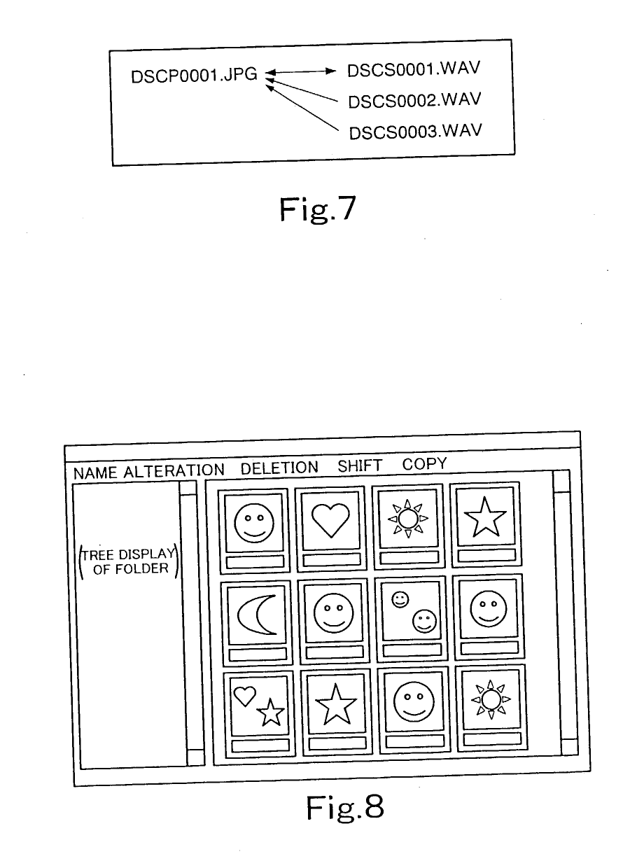

FIG. 7 is a view showing an example of the association between file names of the related files recorded in tags included in a still picture file and a sound file.

In case of the Exif type of file, it is permitted that a file name of at most one related file is recorded on the tag (cf. FIG. 5) included in the file. Even in a case where it is permitted that a plurality of related files exist, it is impossible to record the file names of the plurality of related files on the tag.

FIG. 7 shows an example wherein a plurality of related files exists. Existence of a plurality of related files provides a link structure shown in FIG. 7. That is, the tag of the still picture file of the file name “DSCP0001.JPG” records the file name “DSCS0001.WAV” of the related sound file. On the other hand, the tag of the sound file of the file name “DSCS0001.WAV” records the file name “DSCP0001.JPG” of the related still picture file. Up to here, it is the same as a case where the still picture file of the file name “DSCP0001.JPG” is related with the sound file of the file name “DSCS0001.WAV” on a one-to-one basis. In the event that on the still picture file of the file name “DSCP0001.JPG” there exist not only the related sound file of the file name “DSCS0001.WAV”, but also the related sound file of the file name “DSCS0002.WAV” and the related sound file of the file name “DSCS0003.WAV”, the still picture file of the file name “DSCP0001.JPG” does not record the file name “DSCS0002.WAV” and the file name “DSCS0003.WAV” of the related sound files, but only the tag of the related sound files records the file name “DSCP0001.JPG”. Accordingly, in case of the structure shown in FIG. 7, referring to the tag of the still picture file of the file name “DSCP0001.JPG” makes it difficult to know all the related sound files.

FIG. 8 is a view showing a file processing screen.

On the top of the file processing screen, there are provide four buttons of “name alteration”, “deletion”, “shift” and “copy”. On the left side of the lower portion there are displayed file names of a plurality of folders in a tree structure. On the right side there is displayed a table of thumbnail images represented by still picture files of a folder of interest. Below the respective thumbnail image, there is provided a display column for a file name applied to the related still picture file.

A user can select a desired processing object file from the tree display of the folder or the table of thumbnail images in accordance with the mouse operation. When the user selects any file as the processing object file and clicks through the mouse any one of the four buttons of “name alteration”, “deletion”, “shift” and “copy”, the processing instructed by the mouse click is performed with respect to the selected processing object file.

When any thumbnail image is clicked through the mouse from the table of thumbnail images, the still picture file recording an image corresponding to the thumbnail image is selected. On the other hand, when any file is clicked through the mouse from the tree display of the folder, it is possible to select not only the still picture file, but also the sound file. Here, the explanation will be continued assuming that the still picture file is selected.

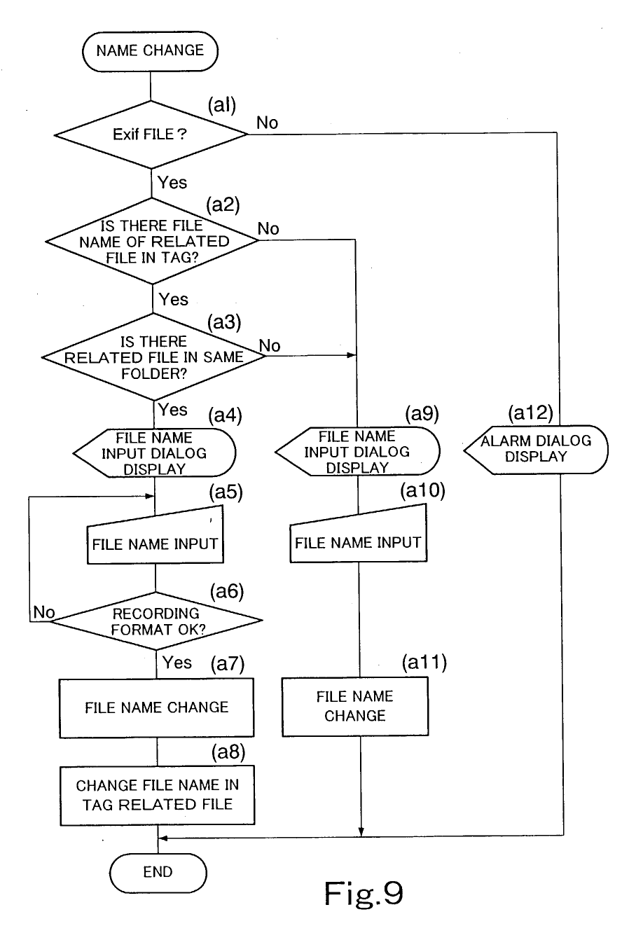

FIG. 9 is a view showing a name alteration processing routine.

Thus, when the still picture file is selected and the button of “name alteration” is clicked, the name alteration processing routine shown in FIG. 9 starts.

When the name alteration processing routine shown in FIG. 9 starts, first, it is decided whether the processing object file of the selected still picture file is an Exif type of file (step a1). In this case, the Exif type of file is the processing object file. Thus, when the processing object file of the selected still picture file is a type of file other than the Exif type of file, an alarm dialog is displayed (step a12).

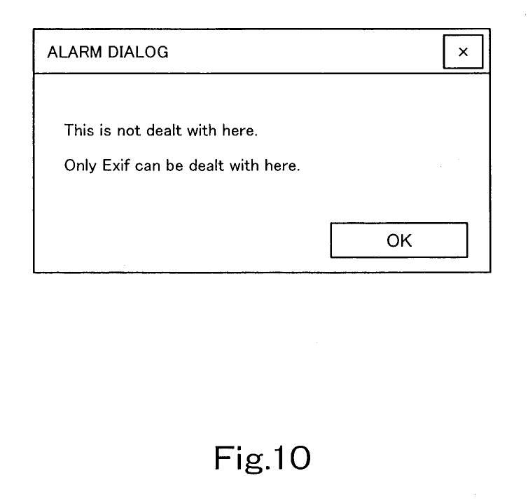

FIG. 10 is a view showing an example of an alarm dialog. Mouse-click of the “OK” button may delete the alarm dialog from the screen.

In the step a1 shown in FIG. 9, when it is decided that the processing object file of the selected still picture file is the Exif type of file, then the tag (cf. FIG. 5) of the processing object file is referred to, and it is decided whether the tag records the file name of the related file (step a2). When the it is decided that the tag records the file name of the related file, the process goes to step a3 in which it is decided whether there exists the related file related with the processing object folder in the same folder as the folder storing the processing object file.

Here, with respect to the decision processing, of the step a3, as to whether the related file exists, there will be explained two modes.

A first mode is concerned with a processing mode wherein the still picture file is related with the sound file only on a one-by-one basis, and it is not permitted that the still picture file is related with the sound file on a one-by-plural basis.

According to the first mode, the file name of the related file recorded on the tag of the processing object file is referred to. When the file name is recorded on the tag of the processing object file, a file having the file name is located from the same folder as the folder storing the processing object file, and recognizes that file as the related file.

A first mode is concerned with a processing mode wherein it is permitted that the still picture file is related with the sound file on a one-by-plural basis.

According to the second mode, when it is confirmed that the file name is recorded on the tag of the processing object file, tags of the file stored in the same folder as the folder storing the processing object file are retrieved one by one, so that the tag recording the file name of the processing object file is located. The file including the tag recording the file name of the processing object file is not always one. The file including the tag recording the file name of the processing object file, thus located, is recognized as the related file.

It is decided in accordance with a situation that only the association of a one-by-one basis or the association of a one-by-plural basis is permitted that the step a3 is constructed with the first mode or the second mode.

When the existence of the related file in the same folder is confirmed in accordance with the first mode or the second mode, the process goes to a step a4 in which a dialog for file name input is displayed.

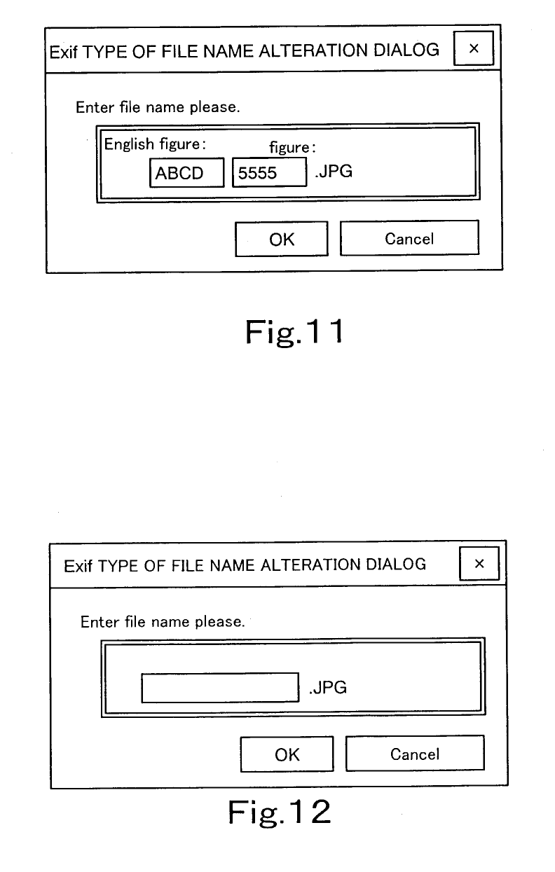

FIG. 11 is a view showing a file name input dialog displayed in the step a4.

Here, in view of the fact that the still picture file is selected, it is permitted that the file name is entered in a recording format of “English figure four letters+figure four digits+. JPG” only. And it is not permitted to enter the file name in another recording format (step a6 of FIG. 9). Thus, with respect to the alteration of the file name, the format of the DCF standards conformity is maintained.

When the file name is entered on the image plane in FIG. 11 (step a5), it is checked whether the file name is properly entered (step a6). When it is decided that the file name is properly entered, the file name of the processing object file is altered (step a7), and in addition the file name of the tag of the related file is also altered to the file name of the processing object file newly entered (step a8).

When it is recognized in the step a2 that the tag of the processing object file does not record the file name of the related file, or alternatively, while the tag of the processing object file records the file name of the related file, when no related file exists indeed in the same folder as the folder storing the processing object file, the process goes to a step a9 in which the dialog for file name input is displayed. Shift and copy of files may cause such a state that while the tag records the file name of the related file, no related file exists indeed. This will be described later.

FIG. 12 is a view showing a file name input dialog displayed in the step a9 in FIG. 9.

This dialog permits, different from the case of the step a4 (FIG. 11) in FIG. 9, to freely enter the file name. The reason why the step a4 (FIG. 11) needs to strictly determine the recording format of the file name is that the memory capacity of the file name is prevented from being changed owing to a result of alteration of the file name of the tag of the related file in the step a8 in FIG. 9, and when no related file exists, it is acceptable to freely alter the file name.

When a new file name is entered on the file name alteration dialog of FIG. 12 and an “OK” button is clicked through the mouse (step a10), the file name of the processing object file is altered (step a11).

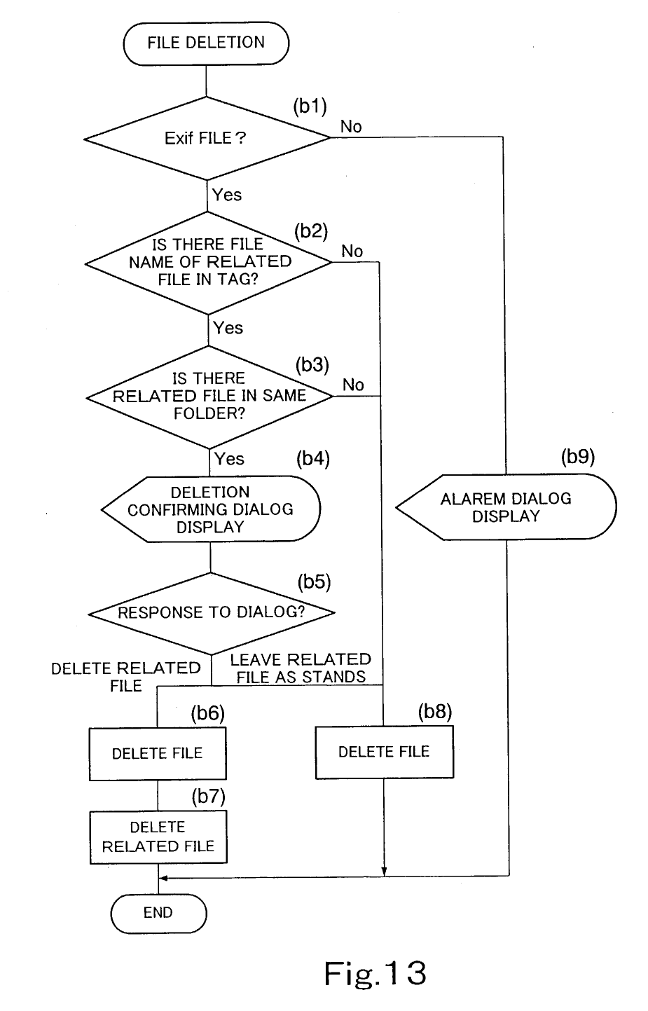

FIG. 13 is a view showing a file deletion processing routine.

When a desired processing object file is selected on the image plane in FIG. 8 and the “deletion” button is clicked, the file deletion processing routine shown in FIG. 13 starts.

Steps b1, b2, b3 and b9 are the same as the steps a1, a2, a3 and a12 of the name alteration processing routine shown in FIG. 9, respectively, and thus the redundant explanation will be omitted.

In step b4 a deletion confirming dialog is displayed.

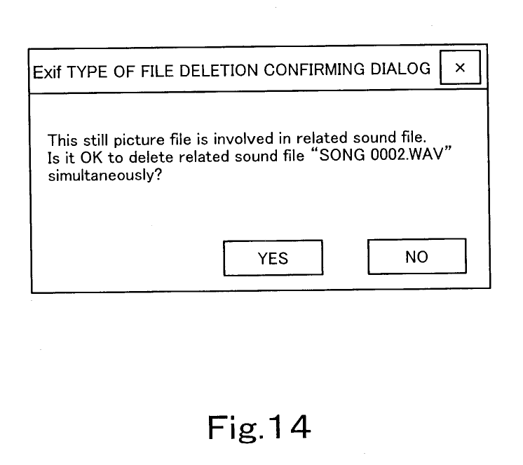

FIG. 14 is a view showing the deletion confirming dialog displayed in the step b4.

Here, as mentioned above, there is explained by way of example a case where the still picture file is selected as the processing object file. The deletion confirming dialog in FIG. 14 indicates that the related sound file of the file name “SONG 0002.WAV” exists in the processing object file (the still image file). When an “YES” button is clicked, it is recognized as an instruction that the related file is also deleted together with the processing object file. When a “NO” button is clicked, it is recognized as an instruction that while the processing object file is deleted, the related file is retained as it is, not be deleted (step b5 in FIG. 13).

When it is instructed that the related file is also deleted, the process goes to a step b6 in which the processing object file is deleted, and then goes to a step b7 in which the related file is also deleted. On the other hand, when it is instructed that the related file is maintained without deletion, the process goes to a step b8 in which only the processing object file is deleted.

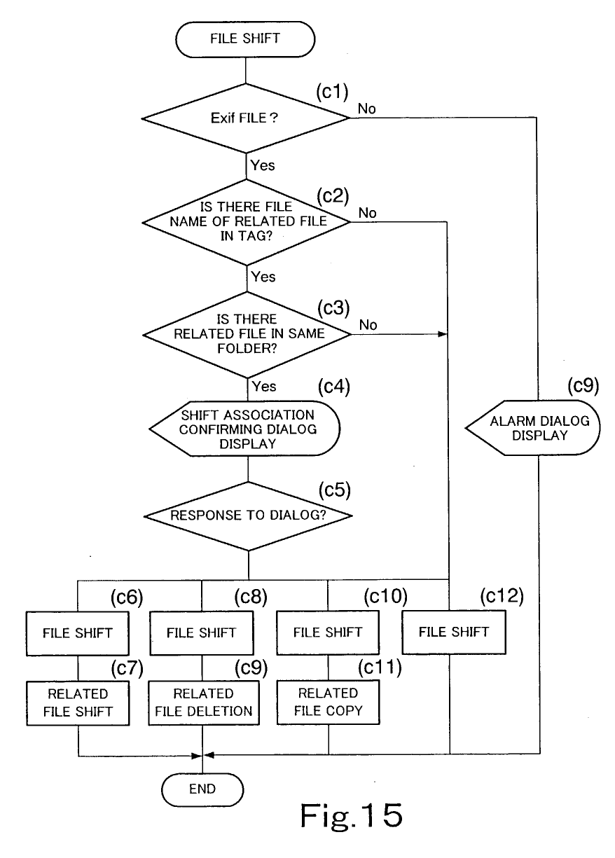

FIG. 15 is a view showing a file shift processing routine.

When a desired processing object file is selected on an image plane of FIG. 8, and the “shift” button is clicked, the file shift processing routine shown in FIG. 15 starts.

Steps c1, c2, c3 and c9 are the same as the steps a1, a2, a3 and a12 of the name alteration processing routine shown in FIG. 9, respectively, and thus the redundant explanation will be omitted.

In step c4 a shift association confirming dialog is displayed.

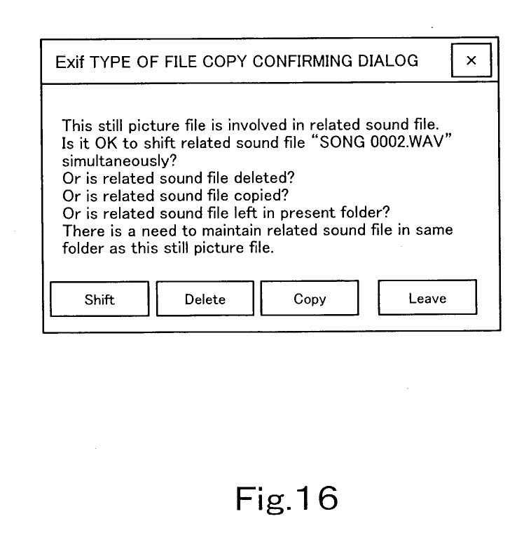

FIG. 16 is a view showing a shift association confirming dialog indicated in the step c4.

Here, as mentioned above, there is explained by way of example a case where the still picture file is selected as the processing object file. The shift association confirming dialog of FIG. 16 indicates that the related sound file of the file name “SONG 0002.WAV” exists in the processing object file (the still image file). There are provided buttons for selecting among a shift of the related sound file together with the processing object file, a deletion of the related sound file, a copy of the related sound file onto a folder of the shift destination of the processing object file, and leaving the related sound file maintained in the folder.

In step c5, it is detected as to which button of the dialog of FIG. 16 is clicked. When the “Shift” button, the “Delete” button, the “Copy” button, and the “Leave” button are clicked, the process goes to steps c6, c8, c10, and c12 in FIG. 15 in which the processing object file is shifted to the folder of the shift destination in accordance with drag and drop operation of the mouse. Further, when the “Shift” button is clicked, the process goes to a step c7 in which the related file is also shifted to the same folder as the folder of the shift destination of the processing object file. Alternatively, when the “Delete” button is clicked, the process goes to a step c9 in which the related file is deleted. Or alternatively, the “Copy” button is clicked, the process goes to a step c11 in which the related file is copied onto the same folder as the folder of the shift destination of the processing object file. As a result, the related file exists in both the former folder and the folder of the shift destination of the processing object file. It is noted that the related file of the former folder is disconnected in link to the processing object file with the shift of the processing object file.

When the “Leave” button is clicked on the dialog image plane of FIG. 16, only the shift processing of the processing object file is performed in a step c12, and none of processing for the related file is performed, so that the related file is left in the former folder.

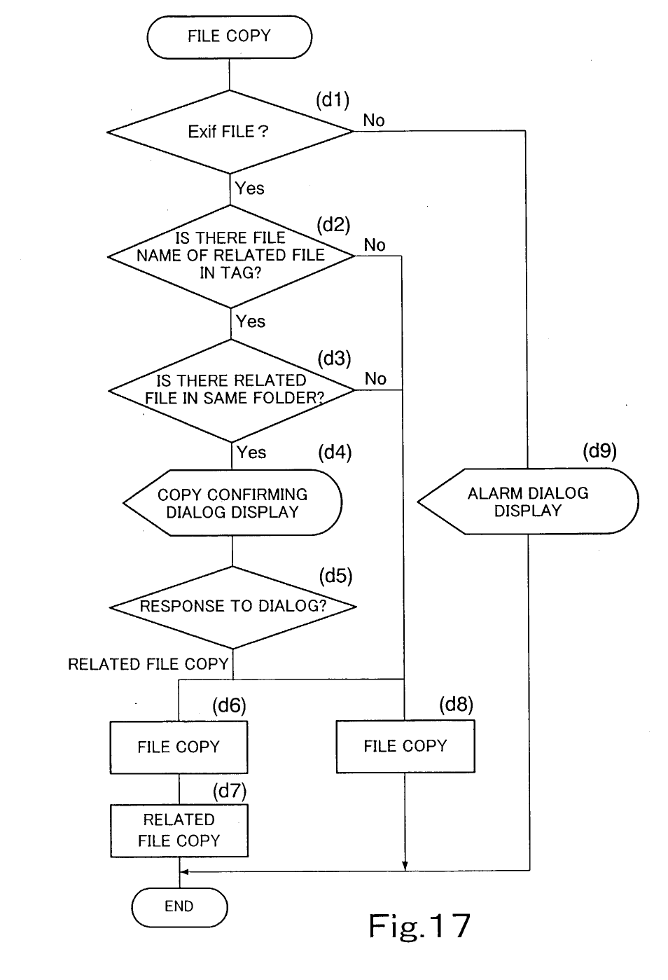

FIG. 17 is a view showing a file copy processing routine.

When a desired processing object file is selected on the image plane of FIG. 8 and the “Copy” button is clicked, the file copy processing routine shown in FIG. 17 starts.

Steps d1, d2, d3 and d9 are the same as the steps a1, a2, a3 and a12 of the name alteration processing routine shown in FIG. 9, respectively, and thus the redundant explanation will be omitted.

In step d4 a copy confirming dialog is displayed.

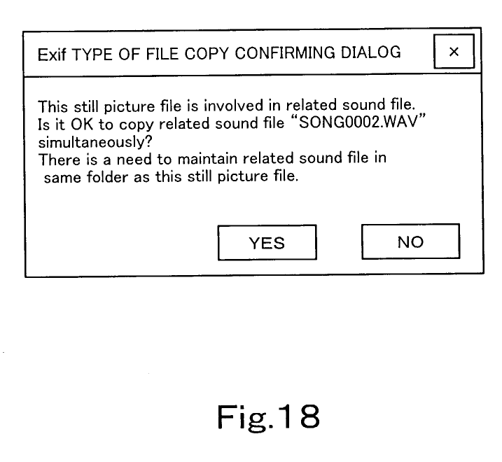

FIG. 18 is a view showing the copy confirming dialog displayed in the step d4.

Here, as mentioned above, there is explained by way of example a case where the still picture file is selected as the processing object file. The copy confirming dialog in FIG. 18 indicates that the related sound file of the file name “SONG 0002.WAV” exists in the processing object file (the still image file). When an “YES” button is clicked, it is recognized as an instruction that the related file is also copied together with the processing object file. When a “NO” button is clicked, it is recognized as an instruction that while the processing object file is copied, the related file is retained as it is, not be copied (step d5 in FIG. 17).

When it is instructed that the related file is also copied, the process goes to a step d6 in which the processing object file is copied onto a new folder by drag and drop operation, and then goes to a step d7 in which the related file is also copied onto the same folder. On the other hand, when it is instructed that the related file is left without copying, the process goes to a step d8 in which only the processing object file is copied onto a new folder by drag and drop operation of the mouse.

As mentioned above, there is explained by way of example a case where the still picture file is selected as the processing object file. In a case where the sound file is selected as the processing file, the still picture file becomes the related file, and the similar processing is performed.

According to the present embodiment, to shift the processing object file, there is provided an arrangement for selecting from among a shift, a deletion, a copy and leaving of the related file. It is acceptable to provide an arrangement for selecting only whether the shift is made, only whether the deletion is made, or only whether the copy is made.

Further, according to the present embodiment, while processing for the related file in deletion, shift or copy of the processing file is left to a user, it is acceptable to unequivocally determine processing for the related file without leaving the processing to the user. That is, it is acceptable that when the processing object file is deleted, the related file is also deleted, when the processing object file is shifted, the related file is also shifted, and when the processing object file is copied, the related file is also copied. Alternatively, it is acceptable that when the processing object file is shifted, the related file is evenly deleted or copied.

Incidentally, according to the present embodiment, there is provided such an explanation that all the functional sections of the present invention are implemented by the PC 100 so that the processing is executed in its entirety.

However, the embodiment of the present invention is not restricted to this embodiment, it is acceptable to provide only functional sections necessary for part of the processing so that the part of processing is executed by the PC 100, that is, only a program for executing processing for implementing the functional sections.

According to the present embodiment, as the operating system operating on the PC 100, there is assumed one having a file system managing a real file with management information (e.g. file names, and storage addresses for real files) different from the real file, such as MS-Windows (registered trade mark) of Microsoft Co. for example. The DSC 700 conforms to DCF standards. Files, which are subjected to photography and recording by the DSC 700 and are subjected to creation and storage by the DSC 700, are under management of this file system. The program of the present invention operates on an operating system having this file system.

In the file operation of the program of the present invention, when alteration of the file name is instructed, the file system executes processing for altering only the file name of the above-mentioned management information without altering substance of the file. When deletion and copy of a file are instructed, processing content of designation is executed for substance of the file, so that the management information is altered. When a shift of a file is instructed, in the event that a file is shifted between folders in the same medium, there is performed processing for altering only the storage address of the management information without altering substance of the file. And in case of the shift operation between the different mediums, there are performed processing for shifting substance of the file to the designated medium and folder and processing altering the storage address of the management information.

Further, according to the present embodiment, while there is made the explanation assuming that both the processing object file and the related file related with the processing object file are each an Exif file, it is acceptable that the processing object file is an Exif file. Further, the processing object file is not restricted to the Exif file, and any one is acceptable, as the processing object file, which has the same file structure provided with a field capable of recording a file name of the related file.

As mentioned above, according to the present invention, it is possible to perform processing for alteration of file names, and deletion, shift or copy of files, without adding a new file for management when the related files exist, upon providing matching on the related files.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A file processing program storage medium storing a file processing program to be executed by an information processing apparatus, said file processing program causing said information processing apparatus to operate as a file processing apparatus for performing a file name alteration processing of a file having a specific file structure in which a tag recording a file name of related file stored in a folder defined as a storage area of a file is included, said file processing apparatus comprising:
a file name alteration instruction section for instructing alteration of a file name of a desired processing object file; and
a file name rewriting processing section receiving a file name alteration instruction for a processing object file by said file name alteration instruction section to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

2. A file processing program storage medium according to claim 1, wherein said a file name rewriting processing section specifies related file in accordance with the file recorded on the tag of the processing object file, and rewrites the file name recorded on the tag of the related file, of the files stored in same folder as the folder storing the processing object file.

3. A file processing program storage medium according to claim 1, wherein said file name rewriting processing section retrieves tags of a file stored in same folder as the folder storing the processing object file to detect related file including a tag recording the file name of the processing object file, and rewrites the file name recorded on the tag of the detected related file.

4. A file processing program storage medium according to claim 1, wherein the file having the specific file structure is a still picture file and a sound file, and the still picture file includes a tag recording a file name of the sound file and the sound file includes a tag recording a file name of the still picture file.

5. A file processing program storage medium according to claim 1, wherein the file having the specific file structure includes a tag recording a file name of only one related file.

6. A file processing program storage medium according to claim 1, wherein the file having the specific file structure is one in which a recording format of the file name of related file recorded on a tag is determined, and said file name alteration instruction section receives only input operation conformed to the recording format for a file name of the processing object file.

7. A file processing program storage medium storing a file processing program to be executed by an information processing apparatus, said file processing program causing said information processing apparatus to operate as a file processing apparatus, said file processing apparatus comprising:
a file processing instruction section for instructing processing for a desired processing object file in accordance with an operation; and
a file processing section receiving a processing instruction for a processing object file by said file processing instruction section to execute processing for the processing object file, and also to execute processing of same contents as said processing for related file linked to the processing object file.

8. A file processing program storage medium according to claim 7, wherein said processing object file has a specific file structure in which a tag recording a file name of related file stored in a folder defined as a storage area of a file is included, and
said file processing section executes said processing where a file including a tag recording the file name of the processing object file of the files stored in the folder storing the processing object file is established as related file linked to the processing object file.

9. A file processing program storage medium according to claim 8, wherein said file processing section specifies related file in accordance with the file recorded on the tag of the processing object file, and executes said processing for the related file of the files stored in same folder as the folder storing the processing object file.

10. A file processing program storage medium according to claim 8, wherein said file processing section retrieves tags of a file stored in same folder as the folder storing the processing object file to detect related file including a tag recording the file name of the processing object file, and executes said processing for the detected related file.

11. A file processing program storage medium according to claim 8, wherein the file having the specific file structure is a still picture file and a sound file, and the still picture file includes a tag recording a file name of the sound file and the sound file includes a tag recording a file name of the still picture file.

12. A file processing program storage medium according to claim 8, wherein the file having the specific file structure includes a tag recording a file name of only one related file.

13. A file processing program storage medium according to claim 7, wherein said file processing apparatus further comprises:
a processing question section receiving an instruction of processing for the processing object file by said file processing instruction section to inquire of an operator whether processing of same content as said processing is executed for the related file linked to the processing object file; and
a propriety instruction section for instructing propriety of execution of said processing for the related file in accordance with an operation of the operator who receives the question by said processing question section, and
said file processing section receives an admission by said propriety instruction section and executes said processing for the related file.

14. A file processing program storage medium according to claim 7, wherein the processing for the processing object file is a deletion of the processing object file, and
said file processing section deletes the related file together with the processing object file.

15. A file processing program storage medium according to claim 7, wherein the processing for the processing object file is a shift of the processing object file, and
said file processing section shifts the processing object file to the folder designated by said operation and shifts the related file to the same folder.

16. A file processing program storage medium according to claim 7, wherein the processing for the processing object file is a copy of the processing object file, and
said file processing section copies the processing object file onto the folder designated by said operation and copies the related file to the same folder.

17. A file processing program storage medium storing a file processing program to be executed by an information processing apparatus, said file processing program causing said information processing apparatus to operate as a file processing apparatus, said file processing apparatus comprising:
a file processing instruction section for instructing processing for a desired processing object file in accordance with an operation; and
a file processing section receiving a processing instruction for a processing object file by said file processing instruction section to execute processing for the processing object file, and also to execute processing of a predetermined content different from said processing for related file linked to the processing object file.

18. A file processing program storage medium according to claim 17, wherein said processing object file has a specific file structure in which a tag recording a file name of related file stored in a folder defined as a storage area of a file is included, and
said file processing section executes said processing of the predetermined content where a file including a tag recording the file name of the processing object file of the files stored in the folder storing the processing object file is established as related file linked to the processing object file.

19. A file processing program storage medium according to claim 18, wherein said a file processing section specifies related file in accordance with the file recorded on the tag of the processing object file, and executes said processing of the predetermined content for the related file of the files stored in same folder as the folder storing the processing object file.

20. A file processing program storage medium according to claim 18, wherein said file processing section retrieves tags of a file stored in same folder as the folder storing the processing object file to detect related file including a tag recording the file name of the processing object file, and executes said processing of the predetermined content for the detected related file.

21. A file processing program storage medium according to claim 18, wherein the file having the specific file structure is a still picture file and a sound file, and the still picture file includes a tag recording a file name of the sound file and the sound file includes a tag recording a file name of the still picture file.

22. A file processing program storage medium according to claim 18, wherein the file having the specific file structure includes a tag recording a file name of only one related file.

23. A file processing program storage medium according to claim 17, wherein said file processing apparatus further comprises:
a processing question section receiving an instruction of processing for the processing object file by said file processing instruction section to inquire of an operator whether said processing of the predetermined content is executed for the related file linked to the processing object file; and
a propriety instruction section for instructing propriety of execution of said processing of the predetermined content for the related file in accordance with an operation of the operator who receives the question by said processing question section, and
said file processing section receives an admission by said propriety instruction section and executes said processing of the predetermined content for the related file.

24. A file processing program storage medium according to claim 17, wherein the processing for the processing object file is a shift of the processing object file, and
said file processing section shifts the processing object file to the folder designated by said operation and deletes the related file as said processing of the predetermined content.

25. A file processing program storage medium according to claim 17, wherein the processing for the processing object file is a shift of the processing object file, and
said file processing section shifts the processing object file to the folder designated by said operation and copies the related file onto the same folder as said processing of the predetermined content.

26. A file processing apparatus for performing a file name alteration processing of a file having a specific file structure in which a tag recording a file name of related file stored in a folder defined as a storage area of a file is included, said file processing apparatus comprising:
a file name alteration instruction section instructing alteration of a file name of a desired processing object file; and
a file name rewriting processing section receiving a file name alteration instruction for a processing object file by said file name alteration instruction section to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

27. A file processing apparatus comprising:
a file processing instruction section instructing processing for a desired processing object file in accordance with an operation; and
a file processing section receiving a processing instruction for a processing object file by said file processing instruction section to execute processing for the processing object file, and also to execute processing of same contents as said processing for related file linked to the processing object file.

28. A file processing apparatus comprising:
a file processing instruction section instructing processing for a desired processing object file in accordance with an operation; and
a file processing section receiving a processing instruction for a processing object file by said file processing instruction section to execute processing for the processing object file, and also to execute processing of a predetermined content different from said processing for related file linked to the processing object file.

29. A method of file processing that performs a file name alteration processing of a file having a specific file structure in which a tag recording a file name of related file stored in a folder defined as a storage area of a file is included, comprising the steps of:
instructing alteration of a file name of a desired processing object file; and
receiving a file name alteration instruction for a processing object file by the step of instructing alteration of a file name of a desired processing object file, to rewrite a file name of the processing object file into a new file name, and to rewrite the file name of the processing object file recorded on a tag of a file including the tag recording the file name of the processing object file where the processing object file is the related file, of the files stored in the folder storing the processing object file, into the new file name.

30. A method of file processing, comprising the steps of:
instructing processing for a desired processing object file in accordance with an operation; and
receiving a processing instruction for a processing object file by the step of instructing processing for a desired processing object file in accordance with an operation, to execute processing for the processing object file, and also to execute processing of same contents as said processing for related file linked to the processing object file.

31. A method of file processing, comprising the steps of:
instructing processing for a desired processing object file in accordance with an operation; and
receiving a processing instruction for a processing object file by the step of instructing processing for a desired processing object file in accordance with an operation, to execute processing for the processing object file, and also to execute processing of a predetermined content different from said processing for related file linked to the processing object file.
